(19) United States
(12) Patent Application Publication
(10) Pub. No.: US 2025/0288929 A1
(43) Pub. Date: Sep. 18, 2025

(54) APPARATUS, SYSTEM, AND METHOD FOR SEPARATION OF WATER FROM AIR

(71) Applicant: UNIVERSITY OF FLORIDA RESEARCH FOUNDATION, INCORPORATED, Gainesville, FL (US)

(72) Inventor: Henry James Edward Tingle, Gainesville, FL (US)

(21) Appl. No.: 19/052,794

(22) Filed: Feb. 13, 2025

Related U.S. Application Data
(60) Provisional application No. 63/564,644, filed on Mar. 13, 2024.

(51) Int. Cl. B01D 45/06; B01D 45/18; B64D 33/10

(52) U.S. Cl. CPC B01D 45/06; B01D 45/18; B64D 33/10

(57) ABSTRACT

A system, apparatus, and method are provided herein to remove water from air aboard an aircraft to permit use of dry air and discharge of water. A system for cooling electronic components of an aircraft includes: an air intake port defined in a forward facing surface of the aircraft; a flow path defined between the air intake port and an air exit port, where the flow path includes at least one bend of at least ninety degrees between the air intake port and the air exit port; and a low-pressure tap line intersecting the flow path proximate the at least one bend, where the low-pressure tap line is in fluidic communication with a water exit port defined in an upward-facing surface of the aircraft.

### CROSS-REFERENCE TO RELATED APPLICATIONS

This application claims priority to U.S. Provisional Application No. 63/564,644, filed on Mar. 13, 2024, the contents of which are hereby incorporated by reference in their entirety.

### TECHNOLOGICAL FIELD

Embodiments of the present disclosure relate generally to separation of water from atmospheric air, and more particularly, to an apparatus, system, and method to remove water from air aboard an aircraft to permit use of dry air and discharge of water.

### BACKGROUND

The separation of water from air is a challenge that has a multitude of uses and applications. The separation of water from air is useful for producing liquid water in environments where such water is a precious commodity. The separation of water from air is also useful for drying air, such as used in removing water from pneumatic systems that use high pressure air to operate tools and/or machinery.

Many devices used to separate water from air involve the use of electricity or other power source to move air through compression and evaporation cycles. This process is effective, though often inefficient and time consuming. Further, many systems that perform the separation of water from air are of relatively large scale and suitable primarily for stationary operation.

### BRIEF SUMMARY

A system, apparatus, and method are provided herein for separation of water from atmospheric air, and more particularly, to an apparatus, system, and method to remove water from air aboard an aircraft to permit use of dry air and discharge of water. According to an example embodiment, a device for separating water from air includes: a body defining an intake port and an exit port, where the body defines a flow path between the intake port and the exit port, where the flow path includes at least one bend; and a low-pressure tap line, where the low-pressure tap line defines a drain path intersecting the flow path proximate the at least one bend.

According to some embodiments, air and water particles enter the air intake port at a relatively high speed and pressure, where the water particles are driven into the at least one bend by the relatively high speed air, and where the water particles are removed from the device by the low-pressure tap line. The body of some embodiments defines a second bend, counter a direction of the at least one bend along the flow path. The flow path of some embodiments defines an S-shaped contour. According to certain embodiments, air and water particles enter through the intake port, water particles exit through the low-pressure tap line, and air with relatively fewer water particles exits the exit port. The intake port of some embodiments is defined in a forward-facing surface of an aircraft. The low-pressure tap line of some embodiments is fluidically connected by way of a conduit to a water exit defined at an area of lower pressure on a surface the aircraft. The exit port of some embodiments supplies air, having less water than air entering the intake port, to ducting for cooling electronic components of the aircraft.

Embodiments provided herein include a system for cooling electronic components of an aircraft including: an air intake port defined in a forward facing surface of the aircraft; a flow path defined between the air intake port and an air exit port, where the flow path includes at least one bend between the air intake port and the air exit port; and a low-pressure tap line intersecting the flow path proximate the at least one bend, where the low-pressure tap line is in fluidic communication with a water exit port defined in a low pressure region of the aircraft.

According to some embodiments, air and water particles enter the air intake port at a relatively high speed and pressure during flight of the aircraft, where the water particles are driven into the at least one bend by the relatively high speed, and where the water particles are removed from the device by the low-pressure tap line. The flow path of some embodiments defines a second bend of at least ninety degrees along the flow path between the air intake port and the air exit port. The air exit port of some embodiments directs air to electronic components housed within the aircraft. According to certain embodiments, air and water particles enter through the air intake port, water particles exit through the low-pressure tap line, and air with relatively fewer water particles exits the air exit port.

Embodiments provided herein include a method including: receiving, at an air intake port, a high pressure flow of air including water particles; directing, along a flow path, the air including water particles to a first bend of in the flow path; receiving, at the first bend, water particles impacting the first bend as the high pressure flow of air continues around the first bend;

siphoning the water particles from proximate the first bend through a low-pressure tap line; and directing the air to an air exit port. The method of an example embodiment further includes discharging the water particles at a water outlet via a conduit, where an air pressure at the water outlet is substantially lower than a pressure of the high pressure air flow. The flow path of some embodiments defines an S-shaped contour. The air intake port of an example embodiment is defined in a forward-facing surface of an aircraft. The water exit port of an example embodiment is defined in an upward-facing surface of the aircraft. The method of some embodiments further includes directing the air from the air exit port to electronic components for dissipating heat from the electronic components.

The features, functions, and advantages that have been discussed can be achieved independently in various embodiments or may be combined in yet other embodiments; further details of which can be seen with reference to the following description and drawings.

### BRIEF DESCRIPTION OF DRAWINGS

Having thus described certain embodiments of the present disclosure in general terms, reference will now be made to the accompanying drawings, which are not necessarily drawn to scale, and wherein:

FIG. 1 illustrates a frontal view of an unmanned aerial vehicle according to an example embodiment of the present disclosure;

FIG. 2 illustrates a profile section view of a fuselage of the unmanned aerial vehicle of FIG. 1 according to an example embodiment of the present disclosure;

FIG. 3 illustrates a detail section view of the water separating air intake device according to an example embodiment of the present disclosure;

FIG. 4 illustrates illustrates a cross-section of an axiosymmetrical embodiment sectioned through a middle of the water separating air intake device according to an example embodiment of the present disclosure; and

FIG. 5 illustrates a front perspective view of the axiosymmetrical water separating air intake device according to an example embodiment of the present disclosure.

### DETAILED DESCRIPTION

The present disclosure now will be described more fully hereinafter with reference to the accompanying drawings, in which some, but not all embodiments are shown. Indeed, this disclosure may be embodied in many different forms and should not be construed as limited to the embodiments set forth herein; rather, these embodiments are provided so that this disclosure will satisfy applicable legal requirements. Like numbers refer to like elements throughout.

The separation of water from atmospheric air is a challenging problem encountered in numerous environments for a variety of purposes. In some embodiments, it is desirable to produce liquid water from the air, while in other embodiments it is desirable to produce dry air while discarding the water. In still further embodiments, the use case benefits from the production of dry air and liquid water.

Embodiments described herein endeavor to remove water from air to produce a flow of dry air to facilitate cooling of components for which water exposure may be undesirable. In particular, embodiments relate generally to the separation of water from air to provide a flow of dry air to cool electronic components of an aircraft. Aircraft electronics are increasingly complex, and with electronic propulsion, additional electrical components and energy storage. Presently, electrical propulsion of aircraft is primarily found in unmanned aircraft, such as drones. However, electrical propulsion of manned aircraft is becoming increasingly popular with improvements to energy storage devices and lightweight structural materials. Thus, while embodiments described herein focus on a use case within an unmanned aerial vehicle, embodiments can be employed in any aircraft, manned or unmanned, regardless of propulsion type as will be appreciated by one of ordinary skill in the art.

Electrical components of vehicles, particularly electrically propelled vehicles, require cooling to operate efficiently and to avoid overheating. Liquid cooling systems are commonly employed to efficiently cool systems, such as a radiator and pump that circulate cooling fluid through a system to draw heat away from cooled components and expel heat through the radiator. While radiators are commonly employed to circulate and cool a liquid coolant, such systems are bulky and heavy, and require a substantial air channel to permit air flow over the radiator. Such systems are not conducive to cooling components in aircraft due to their weight and size, particularly for smaller unmanned aircraft.

Embodiments provided herein employ ambient air for cooling electrical components of an aircraft. As ambient air can include significant amounts of water vapor and water droplets, embodiments described herein further remove water from the ambient air to promote dry air cooling of electrical components to reduce the possibility of corrosion and degradation of the electrical components through exposure to moisture. Additionally, embodiments can dry incoming air before it reaches air condition devices or pumps that pressurize an aircraft cabin. While components ingesting air may include features to reject water or dry air on their own, embodiments of the water separator described herein can improve performance of such water rejection or air drying devices downstream.

Aircraft, and particularly unmanned aerial vehicles that are propelled by electrical propulsion often have a large amount of electronics within the aircraft, such as in the fuselage and/or in the wings in fixed-wing aircraft. The electronics are encased within the aircraft to protect the components from environmental elements and to provide an aerodynamic exterior surface of the aircraft to promote efficient flight. Encasing the electronic components within a body of the aircraft, while necessary, also reduces the ability of the electronic components to effectively dissipate heat. Whether the electrical components are computers/processors for processing data, cameras, or high-powered flight components such as electronic speed controllers, the components require cooling to operate efficiently and effectively, and to promote longevity of the components.

Electronic components can include heat sinks and other features to promote heat dissipation; however, these components may not be sufficient to dissipate enough heat, particularly when encased within a body of the aircraft. Aircraft can include ventilation holes that provide a path for air to pass through the body of the aircraft; however, these holes can also allow entry of water whether in liquid form or vapor. Embodiments described herein employ a specific pathway to create pressure differentials that separate the water from incoming air without needing moving parts or electronics. The lack of moving parts improves reliability and robustness of the system described herein, in addition to avoiding or reducing the amount of service needed to maintain the water separation device described herein. Thus, embodiments are able to separate water from air without consuming power and energy that is at a premium in electrically powered aircraft. The lack of powered components for the water separation systems described herein additionally reduces cost and service requirements, as there are no motors, controllers, or other electronics that require service or redundancy to reliably operate. Further, embodiments described herein can accomplish water separation from air using minimal space within the aircraft. The packaging of components within an aircraft is exceedingly space-concious as space is at a premium. Employing a compact form factor as described herein provides an efficient and effective system for separation of water from intake air as described further below. Further, the lack of moving parts enables the water separating device described herein to be formed within a body or wing of an aircraft without requiring access panels or service intervals, such that embodiments are conducive to integral molding into the wing or body of an aircraft.

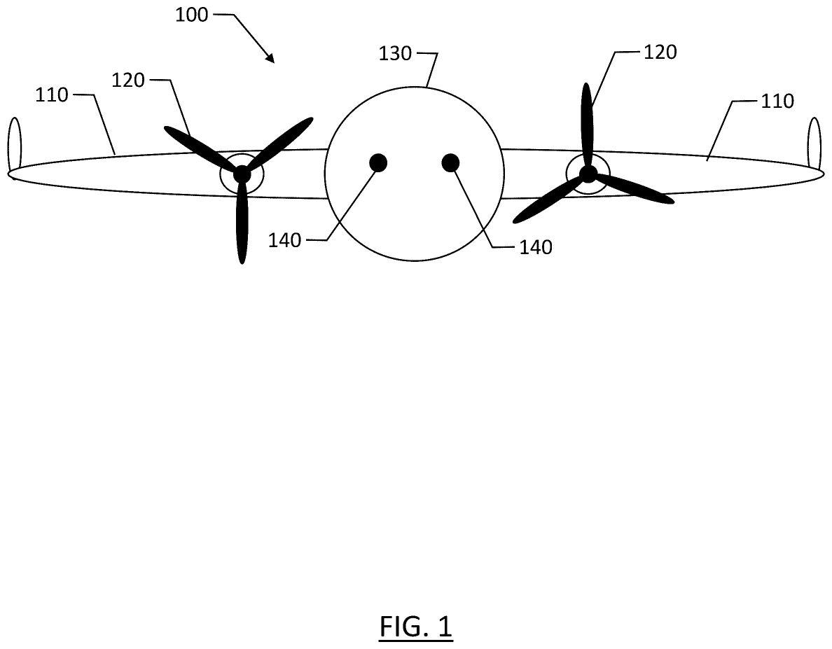

FIG. 1 illustrates a frontal view of an unmanned aerial vehicle (UAV) 100 in the form of a fixed-wing aircraft. As shown, the UAV 100 includes a pair of fixed wings 110, a pair of propellers 120, and a fuselage 130. The propellers 120 may be electrically driven, powered by a combustion engine, or a hybrid power system. Also shown are a pair of air intake ports 140 which enable air to enter the fuselage 130. Passive air intake ports as found in the illustrated embodiment of FIG. 1 can be effective for fixed-wing aircraft that travel in a forward direction at all times when in flight, as there is a continuous supply of air to the air intake ports 140. However, such ports may be less effective when used with rotary wing aircraft due as they are omnidirectional and may hover in a location reducing the likelihood of sufficient airflow.

While air intake ports 140 as shown in FIG. 1 can permit sufficient airflow into a fuselage of a fixed wing aircraft to cool components such as electronics, motors, etc., the ports may also allow water in which can be detrimental to the internal components of the aircraft, and particularly the electronics. Embodiments described herein employ a flow path for air received through the air intake ports 140 that promotes water extraction while enabling relatively drier air to pass through the path and reach the internal electrical components of the aircraft for efficient and effective cooling.

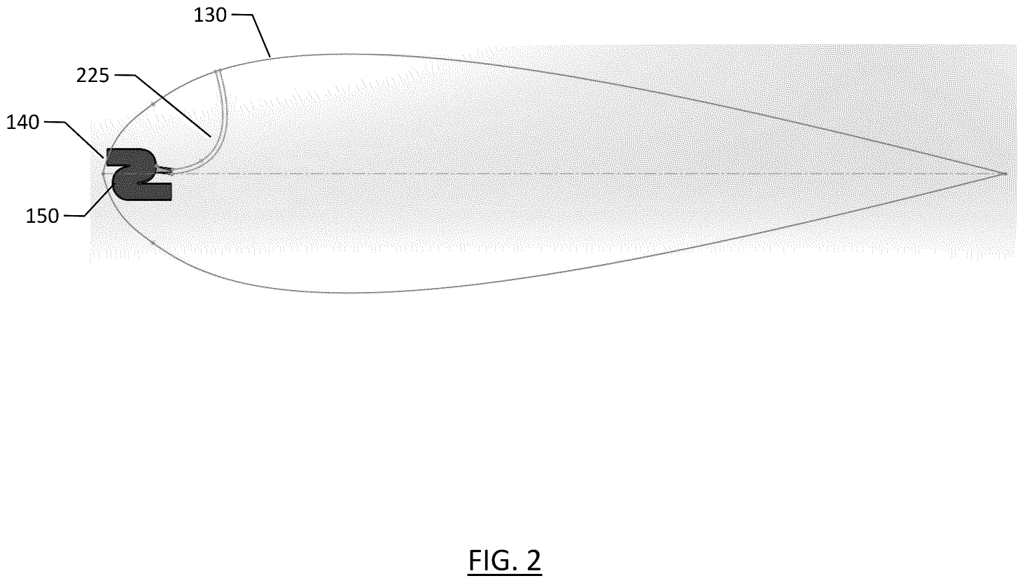

FIG. 2 illustrates a profile section view of the aircraft fuselage 130 of FIG. 1. The section view omits details of components within the fuselage to focus on the air intake device of embodiments described herein. Specifically, the water separating air intake device 150 of FIG. 2 includes the air intake port 140 through which air is received as the aircraft travels through the air.

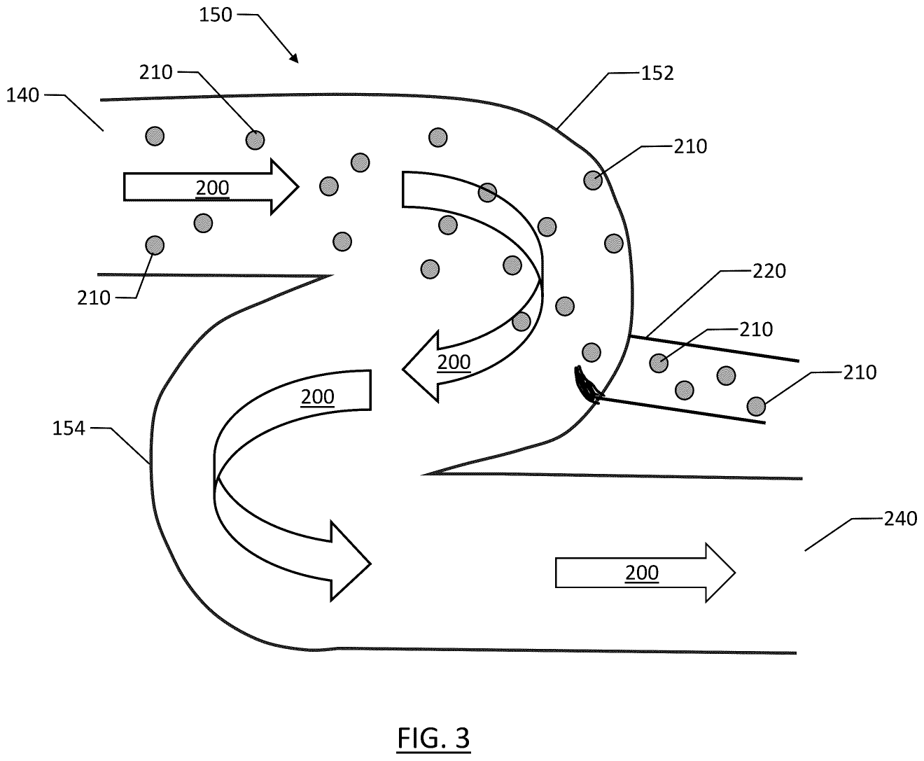

FIG. 3 illustrates a detail section view of the water separating air intake device 150 where intake air is received through air intake port 140. The air 200 along with water 210 (which may be in the form of particles, droplets, etc.) flows in along a substantially horizontal path at speed before encountering a first bend 152 of the device. The air 200 and water 210 enter the device at such speed that upon reaching the first bend 152 of the device, the mass of the water in the airflow results in momentum that precludes the water 210 from completing a turn at the first bend 152, and the water is thrown to the outside of the bend where a low-pressure tap line 220 siphons the water 210 away from the water separating air intake device 150. The air 200 continues to flow around a second bend 154 in the device and exits through an exit port 240.

The first bend 152 shown in the illustrated embodiment is of critical importance to the function of the device described herein. To be effective, the first bend has to define a tortous path for the air flow where it is more difficult for water particles (or any particle suspended within the air) to have greater difficulty navigating the path than the air itself. This is due at least in part to the mass of the particles and their associated momentum. According to example embodiments, the first bend may be of at least ninety degrees. As shown, the first bend is closer to one hundred and eighty degrees as the air almost completely reverses direction within the device. However, the angle of the first bend may be less than one hundred and eighty degrees provided the bend is sufficient to challenge the flow of particles heavier than ambient air. According to some embodiments, the exit flow path of the air may not be in the same direction as the intake flow path of the air. Such an embodiment may be employed in particularly confined space within an aircraft where a linear flowpath of the air is not possible or is undesirable.

While the embodiment of FIG. 3 illustrates an S-curve, the number of curves can be increased for additional opportunities for the water to separate from the air. As the air flows through the device and around the bends, the water particles of varying sizes are unable to follow the curved path due to their mass and momentum. The suction of the low-pressure tap line 220 draws the water particles away from the airflow resulting in relatively drier air exiting the exit port 240 than the intake air at the air intake port 140. This renders the air exiting the device more suitable for cooling sensitive electronic components.

The low-pressure tap line 220 provides a conduit to a water exit proximate a top of the aircraft fuselage or aircraft wing. Optionally, the water exit may be disposed in another area of lower pressure of the aircraft, such as behind rudders, struts, or other features of an aircraft that create low pressure zones. Having the exit of the conduit at the top of a wing or aifoil results in a naturally-occurring area of low pressure above the wing or airfoil in flight to draw air and extracted water through the conduit. Taking advantage of the low pressure zone above the wing, airfoil, or other suitable location of a low pressure zone enables embodiments fo the water separating air intake device described herein to operate in a passive manner without requiring any power or energy to achieve the separation of the water from the intake air beyond any increased drag that the intake port may generate. FIG. 2 illustrates an example embodiment of the conduit 225 extending from the low-pressure tap line 220 and exiting proximate a top of the fuselage 130 of the aircraft.

While the illustrated embodiment above reflects a water separating air intake device 150 disposed within a fuselage, embodiments can operate within a wing of the fixed wing aircraft in a similar manner. Optionally, the water separating air intake device may be located in one of the fuselage or the wing, while the conduit 225 exits through the other of the fuselage or the wing. Positioning the conduit exit atop a wing may provide improved suction due to the shape of a wing providing a greater pressure differential above and below the wing than other surfaces not specifically shaped to provide lift. Other suitable positions include a water exit or low pressure tap at an area of relatively low pressure while an inlet can be positioned at a relatively higher pressure area. This relative positioning promotes removal of the water droplets from the water separating air intake device while allowing the device to be positioned at various potential positions within the aircraft.

According to some embodiments, an air intake port may be shaped to increase a speed with which air enters the water separating air intake device 150. For example, the air intake port can lead to an intake runner with a shape to employ Bernoulli's principal such as through the venturi effect that effectively accelerates the intake air. Such a configuration may be beneficial particularly when an aircraft is capable of flying at lower speeds, where air entering the air intake ports is not traveling as quickly or at higher altitudes where the air is less dense. The venturi effect can improve the function of the water separating air intake device as the air and water particles traveling at a higher speed are more likely to separate the water from the air more effectively.

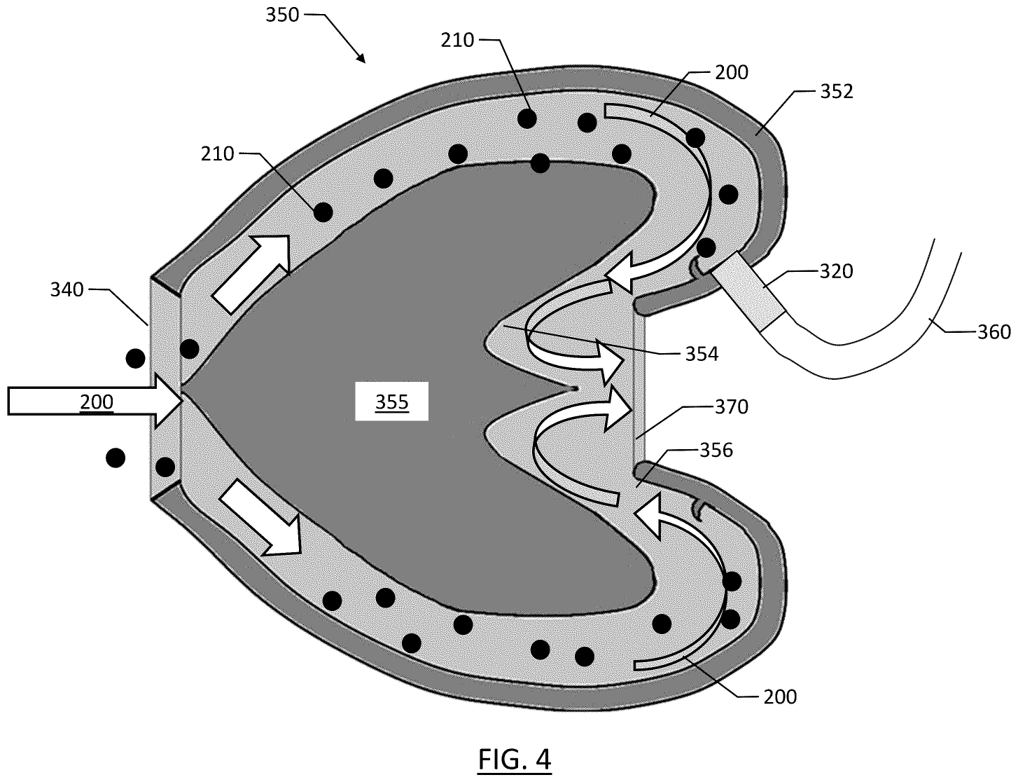

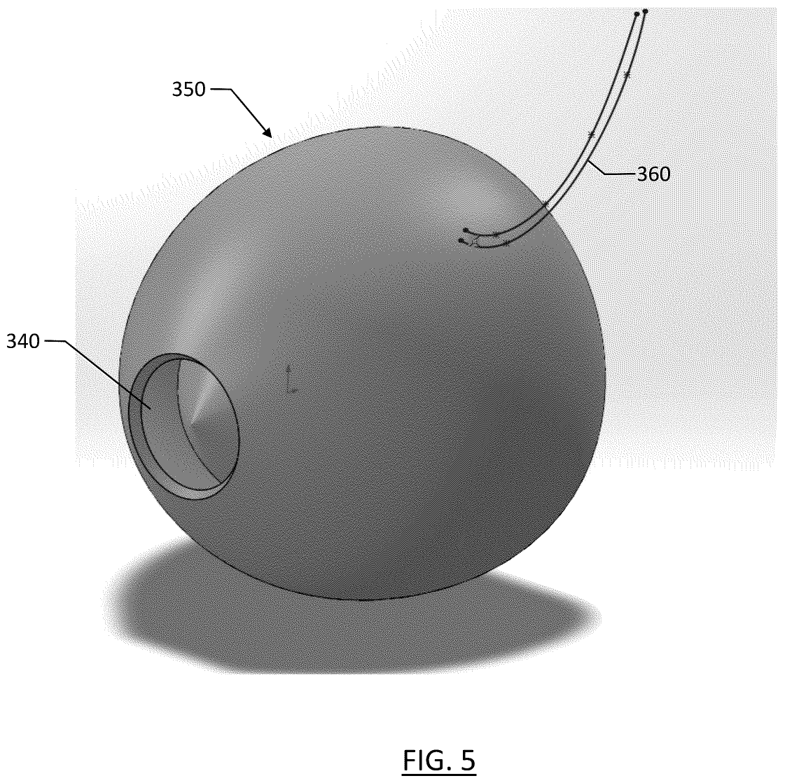

While the illustrated embodiment of the water separating air intake device 150 of FIGS. 2 and 3 can be embodied as a tube, of a round cross section or otherwise, embodiments described herein can be implemented in a variety of different shapes and form factors. FIG. 4 illustrates a cross-section of an axiosymmetrical embodiment sectioned through a middle of the water separating air intake device 350. As shown, the air 200 and water 210 enter the device through an air intake port 340 that is circular. The air flow around a centrally-located hub 355 to a first bend 352. While the air 200 continues around the first bend 352, the water 210 particles momentum carries them into the first bend, and the water is siphoned off through low-pressure tap line 320 and conduit 360. A lip 356 can further deter water 210 from reaching an exit port 370. The air 200 continues from the first bend 352 to a second bend 354 in an aft end of the centrally-located hub 355. The air 200 then flows out of the exit port 370 as relatively drier air for cooling electronic components of the aircraft. FIG. 5 illustrates a front perspective view of the axiosymmetrical water separating air intake device 350 of FIG. 4.

While the illustrated embodiments above include only a single low-pressure tap line, embodiments can include multiple low-pressure tap lines. Such additional low-pressure tap lines may be effective, particularly when positioning an intake of the low-pressure tap line in a lowest point of the water separating air intake device where residual water may settle during use. In the case of the axiosymmetric embodiment of FIGS. 4 and 5, low-pressure tap lines may be disposed about the axis to siphon as much water as possible from the device.

The aforementioned embodiments include receiving air and water particles at a relatively high pressure, with the low-pressure tap line siphoning away water at a relatively low pressure. While specific pressure values are not necessary for understanding, a relatively high pressure may include pressures above an atmospheric pressure or above an ambient pressure surrounding an aircraft employing embodiments of the present disclosure. Similarly, a low-pressure tap operating at relatively low pressure may include a pressure below atmospheric pressure or below an ambient pressure surrounding an aircraft employing embodiments described herein.

For effective functionality of the water separating air intake device of embodiments described herein, proper placement within an aircraft is important. It is desirable to position the air intake port at a location of high pressure while the water exit should be located an an area of lowest pressure. This configuration ensures that there is a maximum pressure differential between air entering the device and suction drawing water out of the device. The position for both the intake port and the water exit would thus be aircraft-specific due to different configurations of fuselage profiles, wing profiles, wing attack angles, etc.

The air exit of water separating air intake devices described herein can be ducted to direct the cool, dry air to the electronic components of the aircraft. This enables electronic components to be safely configured within the fuselage without exposure to water, and thus not requiring high-cost waterproof components that are typically considerably more expensive than their non-waterproof or water resistant equivalents. The cost of production of aircraft is important for scalability and implementation such that cost savings are important whenever possible.

As the skin of an aircraft takes a significant amount of the load placed on an aircraft and is a critical structural element, it is undesirable to have large openings in the aircraft skin. Placing large air intakes or electronic component heat sinks at a surface of the aircraft can compromise the strength and longevity of the structure of the aircraft. Embodiments described herein mitigate this issue by requiring only small openings and exits in the aircraft to implement effective and efficient cooling, while not drawing power.

While the above-described embodiments are conducive to separating water from intake air, embodiments can similarly separate other particles from cooling intake air. For example, dust, dirt, or other debris that can be found in air can enter the water separating air intake devices described above, and these particles would be handled in much the same way as the water particles of the aforementioned examples. According to some embodiments, the devices described herein can be configured to be serviced, such as embodiments that are removable from an aircraft and/or embodiments configured to permit access to the internal chamber of the device. Such access enables cleaning of the air flow path and removal of any debris that was not removed through the low-pressure tap line and conduit.

Many modifications and other embodiments of the disclosure set forth herein will come to mind to one skilled in the art to which these embodiments pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A device for separating water from air comprising:
a body defining an intake port and an exit port, wherein the body defines a flow path between the intake port and the exit port, wherein the flow path includes at least one bend; and
a low-pressure tap line, wherein the low-pressure tap line defines a drain path intersecting the flow path proximate the at least one bend.

2. The device of claim 1, wherein air and water particles enter the intake port at a relatively high speed and pressure, wherein the water particles are driven into the at least one bend by the relatively high speed, and wherein the water particles are removed from the device by the low-pressure tap line.

3. The device of claim 1, wherein the body defines a second bend counter to a direction of the at least one bend along the flow path.

4. The device of claim 3, wherein the flow path defines an S-shaped contour.

5. The device of claim 1, wherein air and water particles enter through the intake port, water particles exit through the low-pressure tap line, and air with relatively fewer water particles exits the exit port.

6. The device of claim 1, wherein the intake port is defined in a forward-facing surface of an aircraft.

7. The device of claim 6, wherein the low-pressure tap line is fluidically connected by way of a conduit to a water exit defined at an area of lower pressure on a surface of the aircraft.

8. The device of claim 7, wherein the exit port supplies air, having less water than air entering the intake port, to ducting for cooling electronic components of the aircraft.

9. A system for cooling electronic components of an aircraft comprising:
an air intake port defined in a forward facing surface of the aircraft;
a flow path defined between the air intake port and an air exit port wherein the flow path includes at least one bend between the air intake port and the air exit port; and
a low-pressure tap line intersecting the flow path proximate the at least one bend, wherein the low-pressure tap line is in fluidic communication with a water exit port defined in a low pressure region of the aircraft.

10. The system of claim 9, wherein air and water particles enter the air intake port at a relatively high speed and pressure during flight of the aircraft, wherein the water particles are driven into the at least one bend by the relatively high speed, and wherein the water particles are removed from the system by the low-pressure tap line.

11. The system of claim 9, wherein the flow path defines a second bend of at least ninety degrees along the flow path between the air intake port and the air exit port.

12. The system of claim 9, wherein the air exit port directs air to electronic components housed within the aircraft.

13. The system of claim 9, wherein air and water particles enter through the air intake port, water particles exit through the low-pressure tap line, and air with relatively fewer water particles exits the air exit port.

14. A method of separating water from air comprising:
receiving, at an air intake port, a high pressure flow of air including water particles;
directing, along a flow path, the air including water particles to a first bend in the flow path;
receiving, at the first bend, water particles impacting the first bend as the high pressure flow of air continues around the first bend;
siphoning the water particles from proximate the first bend through a low-pressure tap line; and
directing the air to an air exit port.

15. The method of claim 14, further comprising:
discharging the water particles at a water outlet via a conduit, wherein an air pressure at the water outlet is substantially lower than a pressure of the high pressure flow of air.

16. The method of claim 15, wherein the flow path defines an S-shaped contour.

17. The method of claim 15, wherein the air intake port is defined in a forward-facing surface of an aircraft.

18. The method of claim 17, wherein the water outlet is defined in an upward-facing surface of the aircraft.

19. The method of claim 14, further comprising:
directing the air from the air exit port to electronic components for dissipating heat from the electronic components.
